(19) United States
(12) Patent Application Publication
(10) Pub. No.: US 2026/0112185 A1
(43) Pub. Date: Apr. 23, 2026

(54) IMAGE BASED ATTRIBUTE GENERATION FOR ITEM DESCRIPTIONS

(71) Applicant: eBay Inc., San Jose, CA (US)

(72) Inventors: Jiaying Gong, Harrison, NJ (US); Janet J. Jenq, Bellevue, WA (US); Hongda Shen, Metuchen, NJ (US)

(73) Assignee: eBay Inc., San Jose, CA (US)

(21) Appl. No.: 19/049,816

(22) Filed: Feb. 10, 2025

Related U.S. Application Data
(60) Provisional application No. 63/708,952, filed on Oct. 18, 2024.

(51) Int. Cl. G06V 20/70; G06F 40/40; G06V 10/774

(52) U.S. Cl. CPC G06V 20/70; G06F 40/40; G06V 10/774

(57) ABSTRACT

Image based attribute generation for item descriptions is described. A computing device receives a digital image depicting an item and encodes one or more embeddings extracted from the digital image using an image encoder. The image encoder is implemented by at least one machine learning model. The one or more embeddings are converted into at least one attribute of the item using a text decoder of the at least one machine learning model that is trained based on a set of attribute training values. A correction for the at least one attribute is generated. Based on the correction and the at least one attribute, item attribute values are extracted including to replace at least one item attribute with a corresponding attribute training value from the set of attribute training values.

### RELATED APPLICATION

This application claims priority under 35 U.S.C. § 119(e) to U.S. Provisional Patent Application No. 63/708,952, filed Oct. 18, 2024, the entire content of which is hereby incorporated by reference.

### BACKGROUND

Computing devices can implement various applications that provide functionality to users, such as captioning digital images to list an item for sale through an online marketplace or post about the item through social media. These applications often utilize machine learning and/or artificial intelligence techniques to process input data and generate useful outputs. These applications, for instance, can implement one or more learning models to capture patterns and relationships in data, enabling the models to make predictions or decisions on new, unseen data. The accuracy of these predictions varies depending on various factors, such as the type of model architecture used, and the specific processes performed to train and retrain the learning models.

### SUMMARY

Techniques are described for image based attribute generation for item descriptions. A system (e.g., an item description system) receives a digital image depicting an item to generate attribute values, which describe various item features and characteristics, for inclusion within an item description (e.g., as part of an image caption or an item listing). For example, without classifying an item depicted by a single digital image, item attributes are generated to describe the item. The system processes a digital image using a machine learning model (e.g., one or more artificial intelligence models and/or machine learning models) that is trained and retrained to generate attributes of an item depicted by the digital image. A text encoder processes image captions of digital images to train the text decoder to derive item attributes from digital images. An image encoder benefits from the text based encoder training to configure the text decoder to implement zero-shot inference directly from the digital image, and without relying on an image caption or other information about the item. Each of the attributes includes model generated text for describing a different characteristic of the item, including visible and hidden features. Combining the attributes enables the system to produce a robust item description based on the digital image alone, e.g., without relying on user inputs or other inputs to the model. The system outputs the item description, for instance, to list the item for sale through an online marketplace, or to post about the item through social media or online publishing.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 is a block diagram depicting an example system that is operable to perform training aspects of image based attribute generation for item descriptions.

FIG. 3 is a block diagram depicting an example system that is operable to perform runtime aspects of image based attribute generation for item descriptions.

FIG. 4 depicts an example of a user interface for listing items using aspects of image based attribute generation for item descriptions.

FIG. 5 is a block diagram depicting an example system that is operable to perform aspects of image based attribute generation for item descriptions.

FIG. 6 is a flow diagram that depicts a procedure performed using aspects of image based attribute generation for item descriptions.

FIG. 7 is a flow diagram that depicts a procedure performed using aspects of image based attribute generation for item descriptions.

FIG. 8 illustrates an example of a system that includes an example computing device that is representative of one or more computing systems and/or devices that may implement the various techniques described herein.

### DETAILED DESCRIPTION

### Overview

A system (e.g., an item description system) is described that implements aspects of image based attribute generation for item descriptions. The system is configured to process a digital image using a machine learning model (e.g., one or more artificial intelligence models and/or machine learning models) that is trained to generate attributes of an item depicted by the digital image. Each of the attributes includes model generated text for describing a different characteristic of the item, including visible and hidden features. For example, the digital image depicts a shirt, and the generated attributes include text describing different aspects of the shirt, such as being a t-shirt type shirt, having a blue color, having a V-neck collar, and so forth. Combining the attributes enables the system to produce a robust item description based on the digital image alone, e.g., without relying on user inputs or other inputs to the model. For describing the shirt, the item description automatically generated from the attributes indicates the shirt is a solid blue V-neck t-shirt. The system is configurable to output the item description, for instance, to list the item for sale through an online marketplace, or to post about the item through social media or online publishing.

Conventional description systems use machine learning models to produce item descriptions based on attributes extracted from digital images, including in some cases attempting to predict unseen attributes not visible from the digital images (e.g., using open-mining, a graph, or large language models). These conventional description systems rely on unimodal or multimodal models, which often request additional inputs (e.g., user generated text to describe an item depicted by a digital image) before an item description can be created from the digital image. For example, a user manually inputs additional information not depicted by the digital image, such as, an item name, an item model, a product identifier, a size, a color, a material, a price, an inventory quantity, and other relevant details. Manually providing additional item information in furtherance of an upload of the digital image, is tedious and time consuming, which diminishes a user experience.

In addition, attribute details inferred by conventional description systems from processing image and manual inputs together can lead to noisy results, which cause inconsistencies, errors, or deficiencies in item descriptions. Item listings, image captions, or other item descriptions that convey inaccurate or incomplete information, whether introduced through manual inputs or inaccurate modeling, risk increasing signaling overhead and usage of computational resources (e.g., processing resources, memory resources, and power consumption) due to exchange of additional signals to complete a task, such as corrected information and/or requests to return or request replacement of items ordered based on inaccurate listings.

As described herein, to address these and other deficiencies of conventional description systems and reduce the use of computational resources related to automatically generating item descriptions from images alone, a system for describing items depicted by digital images is configurable to implement a dynamic (e.g., configurable) approach to automatically generating visible and unseen item attributes, which include concatenable segments of text for building robust item descriptions. For example, the system implements a cross-modal zero-shot attribute generation framework that configures at least one machine learning model to receive individual item images as inputs, and automatically generate corresponding item attributes (e.g., to generate a robust item description), including unseen attributes that are not depicted by the input image.

The system is configurable to receive input from a device that indicates one or more items (e.g., one or more digital images of the one or more items). The input is in the form of a digital image, a digital video, or other visual data representative of the items. For example, a computing device captures one or more digital images of the items and sends the digital images to the system for processing into corresponding item descriptions.

To configure the machine learning model to generate attributes for item descriptions based on the digital image of the item, a text-based training process is used to initialize a projector (e.g., a projector layer) and a text decoder of the model. For example, an image caption model (e.g., a machine learning model pre-trained to output an image caption based on an input image) is used to generate a set of image captions used for training. A set of attribute training values are obtained as additional training data for training the text decoder. A pre-trained text encoder is configurable to extract one or more embeddings from the image captions and the set of attribute training values and encode the embeddings in latent space for use as training inputs to the text decoder. Once trained, the text decoder is configured to convert encoded embeddings into portions of text describing various item attributes.

Following the text-based training process, the pre-trained text encoder of the model is disabled, and a corresponding pre-trained image encoder of the model is activated. The text encoder and the corresponding image encoder are pre-trained in coordination to convert different input modes (e.g., text and image respectively) into compatible embeddings for projecting into a latent space of an input to the text decoder. The text decoder is configured to not discriminate between the embedding types. The text decoder is operable to process embeddings encoded by either text or image encoder because the embeddings are comparable (e.g., the text and image embeddings are projectable into a latent space as comparable attribute embeddings processed by the text decoder). The two encoders are preconfigured to generate comparable embeddings due to a close coupling of the two encoders during each encoder pre-training. Learning capabilities of the two encoders are disabled following the coordinated pre-trainings. The close couplings allow the text encoder to be used to train the text decoder, which allows the image encoder to later be used to perform (e.g., zero-shot) inference with the text decoder to process a digital image of an item. The text decoder is trained generally to recognize embeddings for generating item attributes, which causes the text decoder to be trained to generate comparable or similar results (e.g., item attributes) from comparable embeddings whether encoded by the image encoder or the text encoder.

To improve quality of the item attribute generations, the system is configurable to generate corrections for one or more of the generated attributes. For example, the output from the text decoder in response to a digital image input is combined with a correction obtained by analyzing the digital image using a secondary model. An optical character recognition model is usable to receive the digital image as input and generate optical character recognition outputs (e.g., tokens). An image caption model (e.g., the image caption model used to generate the set of image captions for training the text decoder) is configurable to receive the digital image as input and generate an image caption (e.g., additional tokens). The system is configurable to execute a prompt-based large language model that receives the correction (e.g., the tokens output from the optical character recognition model and/or the image caption model) and updates the item attributes output from the text decoder to produce a robust item description of the item depicted by the digital image, including visible and unseen attributes. In some cases, an item attribute is replaced to align with one of the attribute training values from the set of attribute training values used for training, which improves consistency in terminology used in the outputs from the system.

In some examples, the image caption model discussed above is based on a multimodal large language model (MLLM) framework that receives the digital image as input, and generates an image caption (e.g., descriptive text) based on the digital image. The MLLM framework enables the image caption model to generate a caption pool of one or more caption candidates, with each candidate being generated by a different multimodal large language model using the same digital image. Each candidate describes attributes of an item depicted by the digital image, which are converted from embeddings extracted by a different multimodal large language model from the digital image.

To improve consistency of the caption candidates, the caption candidates generated from a subset of the multimodal large language models are selected by matching portions of caption candidates with a label sets pool (e.g., the set of attribute training values used for training the text decoder) to identify caption candidates useful for describing item attributes. The image caption model is configurable to implement a summarizer to combine the caption candidates from the chosen subset of models with the matching attribute training values obtained from the label sets pool to cause the output from the image caption model, such as the set of image captions used for training the text decoder, the image caption used for correcting an item attribute generated by the system, and so forth, to be concise and accurate.

By configuring the text decoder of the machine learning model of the system to implement a cross-modal zero-shot attribute generation framework, the system is configurable to automatically generate corresponding item attributes from a single digital image. The image caption model of the system enhances performance of the text decoder by deriving corrections and suitable training data to train the framework to generate item attributes that support a robust item description, including unseen attributes that are not depicted by the input image. The image caption model and the text decoder enable the system to avoid generating noisy results, inconsistencies, errors, and deficiencies observed when using conventional description systems. Risks to increasing overhead and computational resource usage are mitigated with the improved results as fewer signals are exchanged to complete a task (e.g., fewer corrections or requests to return items occur when item descriptions and item listing are complete and accurate).

### Example Item Description Generation Environment

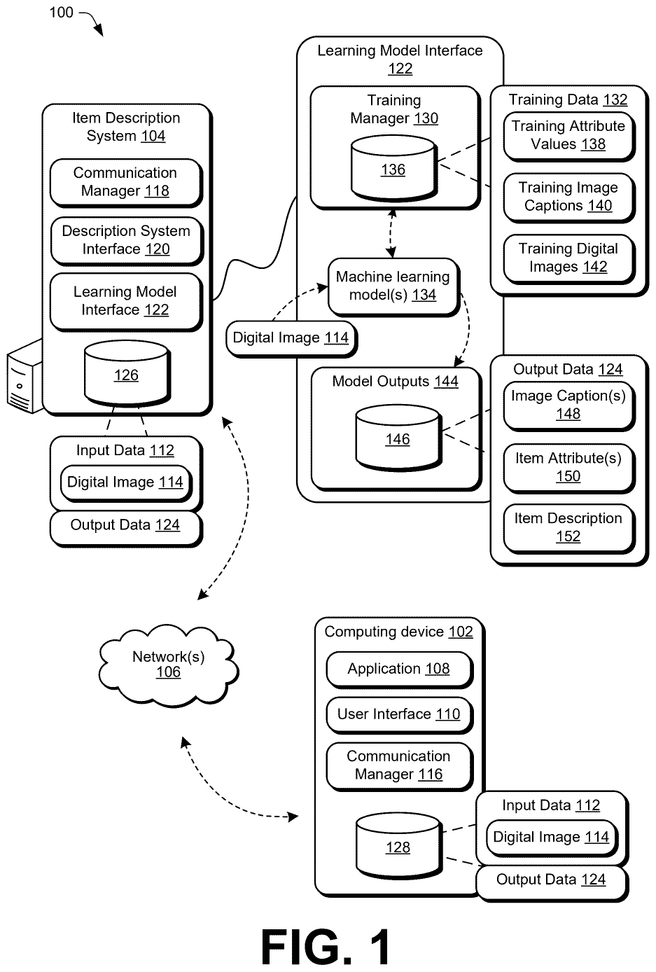

FIG. 1 is an illustration of an environment 100 in an example implementation that is operable to implement image based attribute generation techniques for item descriptions. The environment 100 includes a computing device 102 and an item description system 104. In one or more implementations, the computing device 102 and the item description system 104 are communicatively coupled via one or more networks 106. An example of the networks 106 is the Internet, although the computing device 102 and the item description system 104 are communicatively coupled using one or more different connections or different networks 106 (e.g., wireless networks) in various implementations.

Although the item description system 104 is depicted in the environment 100 as being separate from the computing device 102, in one or more implementations, an entirety, or various portions of the item description system 104 implementable at or by the computing device 102. In at least one implementation, for example, at least a portion of the item description system 104 is implemented by an application 108 of the computing device 102 and/or using various resources of the computing device 102, such as hardware resources, an operating system, firmware, and so forth. Alternatively, or additionally, or alternatively, the item description system 104 is implemented by server-based storage resources, processing resources, and so on of devices other than the computing device 102. For example, at least a portion of the item description system 104 is implemented using a third-party service, such as a web services platform that provides one or more hardware and/or other computing resources to support provision of services by web service providers. In variations, various portions of the item description system 104 are implemented at or by a device of the user (e.g., a mobile device, a laptop, a wearable device, or any other device).

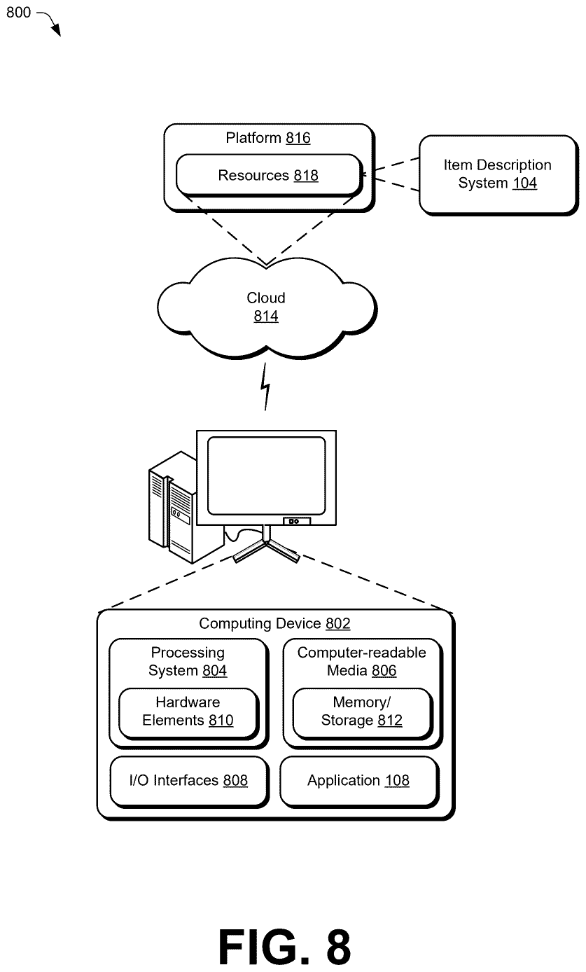

A computing device 102 that implements the environment 100 is configurable in a variety of ways. A computing device 102, for example, is configurable as a desktop computer, a laptop computer, a mobile device (e.g., assuming a handheld configuration such as a tablet or mobile phone), an IoT device, a wearable device (e.g., a smart watch, a ring, or smart glasses), an augmented reality and/or virtual reality device (e.g., the smart glasses), a server, and so forth. Thus, a computing device 102 in the context of this disclosure ranges from full resource devices with substantial memory and processor resources to low-resource devices with limited memory and/or processing resources. Although in instances in the following discussion reference is made to a computing device 102 in the singular, a computing device 102 is also representative of multiple different devices, such as multiple servers of a server farm utilized to perform operations “over the cloud” as further described in relation to FIG. 8.

In at least one implementation, the application 108 supports communication of data across the networks 106 between the computing device 102 and the item description system 104. By supporting such data communication, the application 108 is configurable to provide a respective user of the computing device 102 (e.g., and users of other computing devices) access to image based item description and listing functionality for one or more items pictured in digital images. For example, the computing device 102 receives item description data (e.g., text describing attributes or an item description) from the item description system 104. Based on the received item description data, the application 108 is configurable to cause various systems of the computing device 102 to output at least one user interface 110, such as by displaying the user interface 110 via display devices or making accessible voice-based user interfaces. In some cases, the application 108 is an online marketplace application, such as an e-commerce platform, auction site, or peer-to-peer selling platform, where users can list, buy, and sell various items. The application 108 is configurable to include or interface with social media platforms to post item descriptions to caption digital images or to promote item listings generated from the description and images with marketplace features or specialized marketplaces for categories of items like electronics, fashion, or collectibles.

Through interaction of a user with the computing device 102, the application 108 is configurable to receive user input (e.g., input data 112) via the user interface 110. Examples of such input include, but are not limited to, receiving touch input in relation to portions of a displayed user interface, receiving one or more voice commands or other audio input, receiving typed input (e.g., via a physical or virtual (“soft”) keyboard), receiving mouse or stylus input, and so forth. One example of the application 108 is a browser or other web application that facilitates user interaction with remote captioning and listing functionality with the item description system 104. For example, the user input can include a request to create a listing for one or more items, a request to view existing listings, an indication to modify listing details, or any other user input related to item listing functionality. Another example of the application 108 is a local application that facilitates user interaction with captioning, descripting, and listing functionality, such as a mobile application or a desktop application. The application 108 is configurable in different ways, which provide for users to interact with the computing device 102 and by extension perform actions utilizing the item description system 104 to view, create, or otherwise interact with item attributes, item descriptions, item listings, and so forth, without departing from the spirit or scope of the techniques described herein.

The input data 112 can include data for identifying one or more items to be the subject of an item description or listing. For example, the input data 112 includes a digital image 114 of an item, a video, or any other visual data that conveys item characteristics and features usable by the item description system 104 to detect (e.g., determine, identify) one or more item attributes to support a description or listing of the item.

In some cases, the computing device 102 collects (e.g., obtains, receives) the input data 112 through user interaction with one or more components of the user interface 110 output by the application 108 on the computing device 102. The user interface 110 receives user interactions that cause the computing device 102 to upload the digital image 114 to the item description system 104. Additionally, or alternatively, the input data 112 is automatically captured by one or more sensors (e.g., camera sensors) of the computing device 102. For example, the computing device 102 detects that there are one or more items in a live feed of a camera stream and automatically captures the digital image 114 of the item. The computing device 102 is configurable to send the digital image 114 of the item within the input data 112 to the item description system 104.

The communication manager 116 at the computing device 102 and the communication manager 118 at the item description system 104 is configurable to support communication of data (e.g., the input data 112) across the networks 106 between the computing device 102 and the item description system 104. By supporting such data communication, the communication manager 116 and the communication manager 118 provide for the exchange (e.g., transmission and/or reception) of information, including the input data 112, user input data based on user interactions detected by the computing device 102, and so forth, between the computing device 102 and the item description system 104. Thus, the item description system 104 is configurable to receive the input data 112 from the computing device 102 and process the digital image 114 obtained from the input data 112 to perform functions for generating item attributes and item descriptions (e.g., captions) of an item depicted by the digital image 114.

A description system interface 120 of the item description system 104 manages operations for processing the input data 112 received from the computing device 102. By accessing a learning model interface 122 of the item description system 104, the description system interface 120 causes the item description system 104 to generate output data 124 based on the digital image 114. In some cases, the description system interface 120 and/or the learning model interface 122 are each an example of an application programming interface (API), which is accessible via function calls in executable firmware and software (e.g., the application 108) when the computing device 102 and the item description system 104 share a connection through the networks 106.

The description system interface 120 maintains the input data 112 received from the computing device 102 in a data storage 126 for further processing. As used herein, the term data storage includes one or more databases and/or other types of storage capable of storing relevant data. Examples include, but are not limited to, mass storage and virtual storage. In one or more implementations, for example, a data storage is virtualized across multiple data centers and/or cloud-based storage devices.

The output data 124 generated through access to the learning model interface 122 is preservable in the data storage 126 for additional processing, however, in at least one example, the output data 124 is immediately transmitted to the computing device 102 to improve performance, e.g., without maintaining an intermediary copy of the output data 124 in the data storage 126. The computing device 102 includes a data storage 128 configured to maintain the input data 112 and the output data 124 on behalf of the application 108. For example, the application 108 writes the input data 112 to the data storage 128, and the communication manager 116 sends the input data 112 retrieved from the data storage 128 to the description system interface 120 for storage at the data storage 126. The application 108 writes the output data 124 to the data storage 128 when the communication manager 116 receives the output data 124 having been retrieved by the communication manager 118 from the data storage 126.

A training manager 130 of the learning model interface 122 is configurable to provide access to training data 132 that is usable to train one or more machine learning models 134. The training manager 130 manages and maintains access to a data storage 136 to retrieve and provide the training data 132 into a training input of one or more of the machine learning models 134. The training data 132 is shown having a set of training attribute values 138, training image captions 140, and training digital images 142 each describing or depicting at least one item. The training manager 130 is configurable to use various machine learning techniques, such as supervised learning, unsupervised learning, or reinforcement learning, to update the parameters of the machine learning models 134. This process involves techniques like gradient descent, backpropagation, or ensemble methods to improve the predictive capabilities of the learning models 134, such as described below with reference to the additional figures.

The training manager 130 is configured to train the machine learning models 134 to generate the output data 124 based on the digital image 114. The machine learning models 134 are configurable to generate model outputs 144 to convey the output data 124. The model outputs 144 are preserved in a data storage 146. For example, the data storage 146 is a portion of the data storage 126 configured to store the output data 124 in a different region of the data storage 126 as the input data 112 and the digital image 114.

The training process in variations involves providing the training data 132 as input to the machine learning models 134 and updating weights and biases of the machine learning models 134 using either labels included in the training data 132 (e.g., for supervised learning) and/or patterns in the training data 132 (e.g., for unsupervised learning). In some examples, the machine learning models 134 include gradient boosting models, deep neural networks (e.g., CNNs), and recurrent neural networks (RNNs), encoders, decoders, or transformers.

In some examples, a control for automatically generating the output data 124 is displayed on the user interface 110, and a user interacts with the control to initiate an automatic item description process performed by the item description system 104 using the machine learning models 134. For example, the computing device 102 receives user input at the control and sends a request to the item description system 104 to generate the output data 124 based on the digital image 114. The item description system 104 is configurable to utilize the digital image 114 to automatically generate item attributes 150 for producing an item description 152 or an image caption 148 or populate listing fields of an item listing with relevant information conveyed by the output data 124. Each of the item attributes 150 includes text generated by one or more of the machine learning models 134 for describing a different characteristic of the item depicted by the digital image 114, including visible and hidden features of the item. The item description 152 includes descriptive textual content for describing an item listing for the item, for example. In another example, the item description 152 supports the image caption 148 (e.g., for presentation near the digital image 114 in the user interface 110).

In some cases, once the item description system 104 automatically generates the output data 124, the computing device 102 presents the image caption 148, the item attributes 150, and/or the item description 152 (e.g., via the user interface 110) for review and approval before publication. A user of the computing device 102 has an opportunity to provide for user input that indicates adjustments or customizations to the output data 124. A user input at the user interface 110, for instance, includes text describing a specific attribute to be included among the item attributes 150. The learning model interface 122 is configured to interpret the user input as a prompt describing the specific attribute to include when generating the item attributes 150 and/or the item description 152. In some other cases, once the item description system 104 automatically generates the output data 124, the item description system 104 publishes the output data 124 without additional review (e.g., based on user defined settings). For example, the output data 124 is packaged into an item listing for the item depicted by the digital image 114, and the item description system 104 automatically outputs the item listing for publishing through an item listing service connected to the networks 106. In variations, the item description 152, the item attributes 150, and/or the image captions 148 are generated automatically in response to receiving the digital image 114, without receiving intermediary user input, such as a prompt.

Publishing the output data 124 in one or more examples includes making the image caption 148, the item attributes 150, and/or the item description 152 visible and accessible to other users of an online service, application, platform, or marketplace (e.g., the application 108). The publishing includes one or more of indexing the output data 124 in a search database of the application 108, assigning the output data 124 to relevant categories, and activating features selected for the output data 124. Once published, one or more users of the application 108 interact with or engage with the output data 124 by searching for, selecting (e.g., clicking on), viewing, purchasing, providing feedback (e.g., a review of), or performing another action at the user discretion, e.g., in relation to the image caption 148, the item attributes 150, and/or the item description 152 included in the output data 124.

The item description system 104 leverages the machine learning models 134 to analyze the input data 112 to improve computational resource allocation for describing items depicted by digital images for captioning or generating item listing. For example, the item description system 104 automatically generates attributes of an item depicted by the digital image 114 without classifying the item. A conventional description system classifies an item depicted by a digital image, and then predicts attributes of that item based on the classification. In contrast, the item description system 104 does not inherit the bias of a classification system, and instead generatively produces item attributes to achieve zero-shot inference, including for items that have not been previously described. Thus, by generatively producing the item attributes, the item description system 104 is configurable to improve computational resource allocation for digital image based item description, captioning, and item listing creation by preventing noisy results, inconsistencies, errors, and deficiencies in the output data 124, which is often observed when using conventional description systems. Risks to increasing overhead and computational resource usage are mitigated with the improved accuracy of the output data 124, as fewer signals are exchanged through the networks 106 for the computing device 102 and the item description system to complete a task.

The item description system 104 is configurable to implement the description system interface 120 and the learning model interface 122 by using servers that execute stored instructions to deploy various services of the item description system 104, such that those services perform numerous computations effective to provide the functionality described above and below. It is to be appreciated that the item description system 104 and/or the computing device 102 includes more, fewer, or different components in different implementations, without departing from the spirit or scope described herein.

Having considered an example of an environment, consider now a discussion of some example details of the techniques for dynamic automatic generation of item listings in accordance with one or more implementations.

### Automatic Generation of Item Attributes

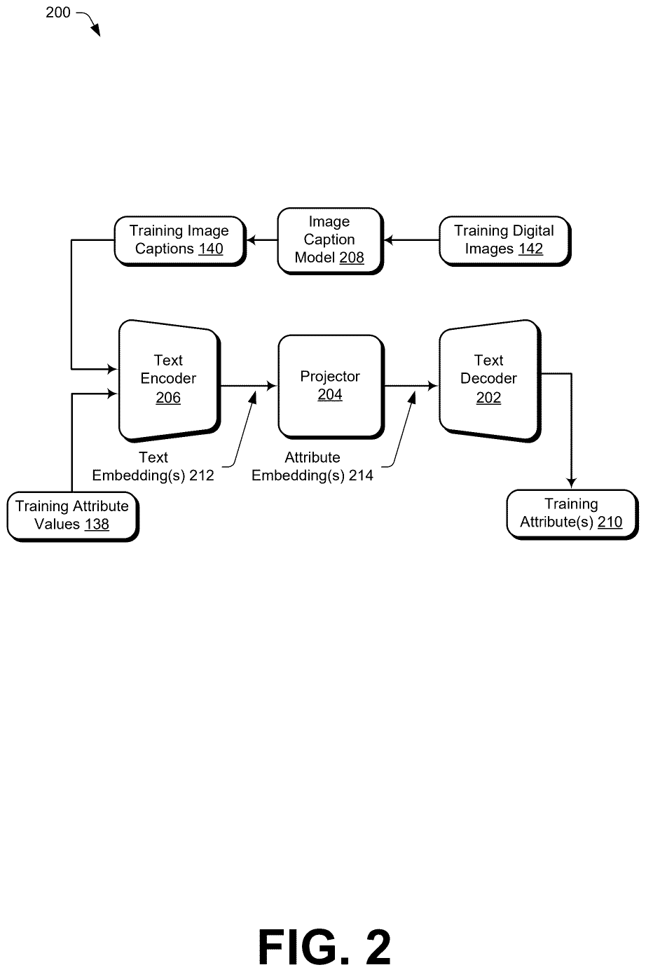

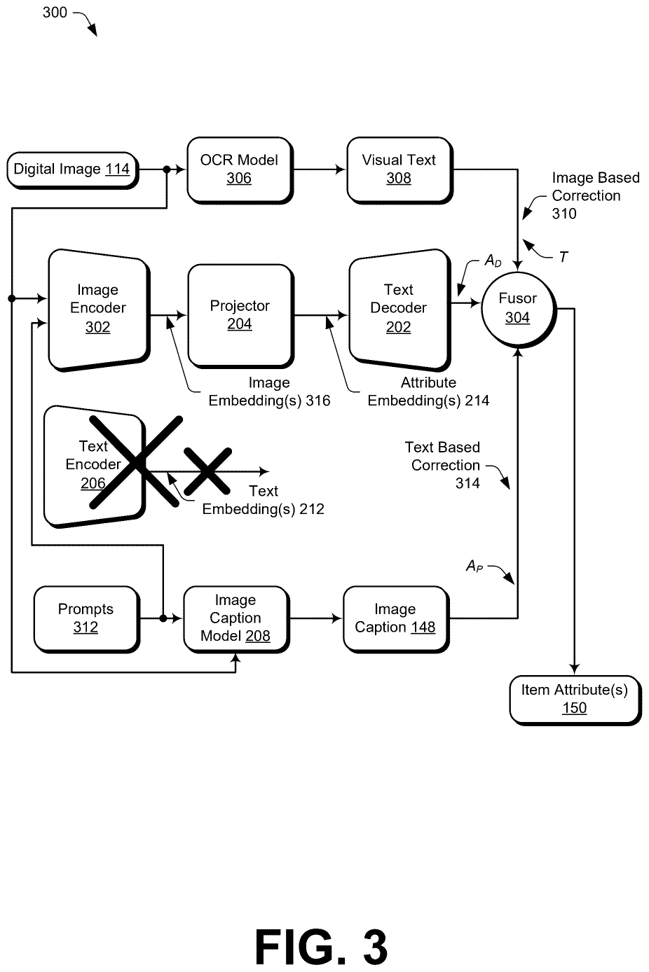

FIG. 2 is a block diagram depicting an example system 200 that is operable to perform training aspects of image based attribute generation for item descriptions. FIG. 3 is a block diagram depicting an example system 300 that is operable to perform runtime aspects of image based attribute generation for item descriptions. FIGS. 2 and 3 are described together in the context of elements depicted in FIG. 1. The systems 200 and 300 illustrate detailed implementations of the machine learning models 134. For example, the system 200 illustrates a training example of the machine learning models 134, and the system 300 depicts an inference example (e.g., zero-shot inference) performed using the machine learning models 134, after being trained by the system 200.

Turning first to the system 200 depicted by FIG. 2, the training manager 130 configures the machine learning models 134 to adopt a training framework utilizing a text decoder 202, a projector 204 (e.g., a projector layer of the machine learning models 134), and a text encoder 206. The system 200 activates the text encoder 206 to train the text decoder 202 and the projector 204 to create the output data 124 (e.g., the item attributes 150) based on text embeddings 212 (e.g., a feature vector of an item) generated by the text encoder 206.

The text decoder 202 represents at least part of the machine learning models 134 that is trained to convert attribute embeddings 214 received from the projector 204 into portions of text describing at least one of the item attributes 150 or other aspect of the output data 124. For example, the text decoder 202 is a generative artificial intelligence model (e.g., a large language model) configured as a generative language decoder that outputs descriptive text from the attribute embeddings 214, whether the attribute embeddings 214 are extracted from the text embeddings 212 or image embeddings 316, as depicted in and described with respect to image encoder 302 of FIG. 3. The projector 204 is configured to convert text or image embeddings from an encoder latent space into the attribute embeddings 214, which are mapped to a decoder latent space. For example, the projector 204 is trainable to transform the text embeddings 212 output from the text decoder 202 and the image embeddings 316 output from the image encoder 302 into compatible embeddings for a latent space of the text decoder 202. The projector 204, for instance, converts the text embeddings 212 and the image embeddings 316 from a first latent space corresponding to the text encoder 206 and the image encoder 302 to be used as the attribute embeddings 214 in a second latent space (e.g., with different dimensions than the first latent space) of the text decoder 202.

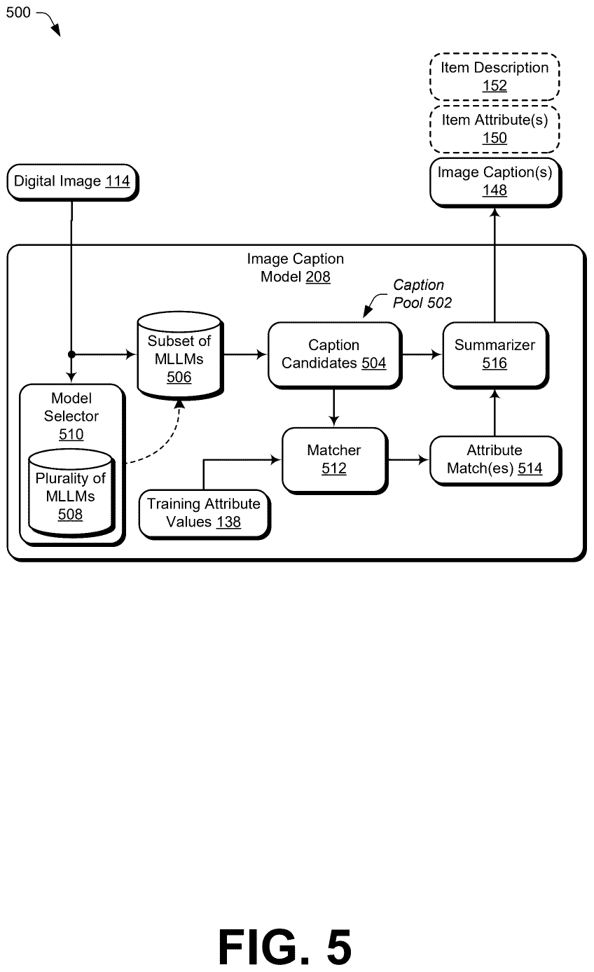

An image caption model 208 is generally configured to output an image caption by analyzing a digital image input. The image caption model 208 is an example of one of the machine learning models 134 and is configurable to generate the training image captions 140 for training the text decoder 202 by processing a corresponding training image from the training digital images 142. Numerous examples image captioning models are useable as the image caption model 208. For example, the image caption model 208 is a generative artificial intelligence model (e.g., a large language model or a neural network) or other type of machine learning model. A detailed example of the image caption model 208 is described below with reference to FIG. 5.

Each pair of the training image captions 140 and corresponding training digital images is input to the text encoder 206, along with the training attribute values 138. The training attribute values 138 help guide the text encoder 206 into generating useful text embeddings 212 based on the training inputs, e.g., for the purpose of enabling the text decoder 202 to identify training attributes 210 extracted from the attribute embeddings 214 of items described by the training image captions 140 and/or the training attribute values 138.

The text encoder 206, in at least one example, is part of a Contrastive Language-Image Pre-Training (CLIP) model, which also includes a matching image encoder 302 depicted in FIG. 3. The system 200 enables the text encoder 206 to train the text decoder 202, and the system 300 uses the image encoder 302 to perform zero-shot inference using the text decoder 202, once trained. As part of the same CLIP model, the text encoder 206 and the image encoder 302 are pre-trained in coordination to configure each encoder to extract comparable feature vectors (e.g., the text embeddings 212 are comparable with the image embeddings 316) from shared training data that includes multiple image and caption pairs. The text encoder 206 and the image encoder 302 are preconfigured to generate the text embeddings 212 and the comparable image embeddings 316 due to a tight coupling of the text encoder 206 and the image encoder 302 during each respective pre-training session. For example, a loss function comparing the text embeddings 212 output from the text encoder 206 and the image embeddings 316 output from the image encoder 302 is optimized for encoding similar embeddings and deriving equivalent feature vectors based directly on the training digital images 142, and indirectly on the training image captions 140.

The text encoder 206 is configurable to generate a feature vector for an image caption by extracting one or more text embeddings 212, and the image encoder 302 is configurable to generate a similar or equivalent feature vector as the text encoder 206 by extracting one or more image embeddings 316 when processing an image that corresponds to the image caption used by the text encoder 206. By pre-training, the text encoder 206 and the image encoder 302 in coordination (e.g., as part of a CLIP model), a less complex (e.g., text-based) training process can be used to train the text decoder 202 to identify item attributes from digital images. When implemented in the system 200 and the system 300, respective learning capabilities each of the text encoder 206 and the image encoder 302 are disabled. The respective parameters of the text encoder 206 and the image encoder 302 are fixed (e.g., set to read-only), which configures the text encoder 206 and the image encoder 302 to achieve consistency generating comparable text and image embeddings over time, regardless of whether the embeddings are extracted from images or text. The training image captions 140 generated by the image caption model 208 are concatenated with the training attribute values 138 to prevent overfitting of the text decoder 202 and improve the generalization and robustness of the text decoder 202.

The text embeddings 212 mapped to a CLIP space by the text encoder 206 are projected to the text decoder 202 and decoded into the training attributes 210. An objective of the text-only training process discussed above attempts to reduce the following:

$${\sum }_{A ∈ T} ℒ ( {D}_{T} ( W \cdot {E}_{T}^{*} ( A ⊕ {M}^{*} ( I ) ) + b ) , A ) \qquad Equation ( 1 )$$

In Equation (1), the symbol * denotes a fixed, frozen, or unchangeable model with parameters that are not updated during training. The symbol M* represents the image caption model 208, and I is the training image processed by the image caption model 208. The symbol [symbol] is an autoregressive cross-entropy loss for multiple tokens in A. The projector 204 is represented by the symbols W and b, to indicate the projector 204 as being a trainable layer for domain alignment and dimension adjustment. The projector 204 alleviates the modality gap connecting an image domain at the input to the machine learning models 134 with a text domain at the output of the machine learning models 134.

Once trained, the training manager 130 reconfigures the machine learning models 134 to have an architecture of the system 300, which allows the machine learning models 134 to perform zero-shot inference to generate the output data 124 based on a single digital image input, such as the digital image 114. After training the text decoder 202 to process the text embeddings 212 extracted by the text encoder 206, the system 300 disables the text encoder 206 and activates the image encoder 302 to perform zero-shot inference to identify item attributes of items depicted by individual digital images. The disabling of the text encoder 206 is shown in FIG. 3 by an X marked over the text encoder 206 and an X marked over the text embeddings 212. The text encoder 206 is in an active state or configured to refrain from outputting the text embeddings 212, for example. Or, in some examples, the text encoder 206 remains active in the system 300 (e.g., generates the text embeddings 212), however the output of the text encoder 206 is ignored by the system 300. The image encoder 302 is activated to extract the image embeddings 316 from the digital image 114. Having been trained to process the text embeddings 212, the projector 204 and the text decoder 202 are also trained to transform the comparable image embeddings 316 extracted by the image encoder 302.

The digital image 114 is received as input to the image encoder 302, from which the image encoder 302 extracts the image embeddings 316. The projector 204 is configured to convert the image embeddings 316 output from the image encoder 302 into a latent space of the text decoder 202 for generating the item attributes 150, and optionally, the item description 152, including unseen attributes of the item that are not depicted by the digital image 114. The projector 204 transforms the image embeddings 316 extracted by the image encoder 302 to appear in a latent space that has the corresponding dimensions of the text decoder 202. The text decoder 202 outputs the item attributes 150 and/or the item description 152 based on the digital image 114. Disabling the text encoder 206 in favor of enabling the image encoder 302, seamlessly reconfigures the text decoder 202 to generate the output data 124 from the image embeddings 316 extracted from a single, digital image 114. The output data 124 is generated automatically and without receiving additional inputs, such as user inputs, title information, classifications, descriptive text, and so forth.

Consider the digital image 114, represented by the symbol I. The digital image 114, e.g., I, is input into the text decoder 202, represented by the symbol D_{T}, and which is trained to generate the item attributes 150, represented by the symbol A_{D}. The image encoder 302, represented by the symbol E_{I}*, extracts the image embeddings 316 from the digital image 114. The projector 204, which having been trained by the system 200, is represented by the symbols W+b to perform modality gap alleviation to convert the attribute embeddings 214 projected from the image embeddings 316 into textual aspects for generating the item attributes 150 based on the following:

$${A}_{D} = {D}_{T} ( W \cdot {E}_{I}^{*} ( I ) + b ) \qquad Equation ( 2 )$$

To improve the zero-shot performance when out-of-domain attribute values are reported from the text decoder 202, a fusor 304 is activated to correct errors in the outputs, A_{D}, from the text decoder 202, D_{T}. In the illustrated example of FIG. 3, the fusor 304 receives two possible corrections, an image based correction 310 and a text based correction 314. In some cases, a single correction or more than two corrections are applied by the fusor 304 to the output A_{D} of the text decoder 202 to generate the item attributes 150. The image based correction 310 is based on optical character recognition text (e.g., the visual text 308) generated from optical character recognition performed by the OCR model 306 based on the digital image 114. The text based correction 314 is based on an image caption generated by the image caption model 208 based on the digital image 114, and in some examples, a specific attribute or multiple specific attributes described by the prompts 312. The system 300 is configured to interpret the prompts 312 describing the specific attribute to include when generating the item attributes 150 and/or the item description 152. For example, the prompts 312 are received in response to a user input at the user interface 110. The prompts 312 include text, for instance, which describes a specific attribute (e.g., a prominent feature, a non-visible feature from the digital image 114) to be included among the item attributes 150. The image encoder 302 and the image caption model 208 are each configured to receive the prompts 312 as input for improving the output A_{D} of the text encoder and the text based correction 314, respectively, by including the specific attribute mentioned, or an equivalent attribute. The image encoder 302 is configurable to encode the one or more image embeddings 316 extracted from the digital image 114 by encoding the one or more image embeddings 316 based further on the prompts 312 requesting the specific attribute. A user has an opportunity through the prompts 312 to control aspects of the item attributes 150 and/or the item description 152 (e.g., to ensure the specific attribute is included in the output).

In at least one example, the fusor 304 determines whether the item attributes 150 output from the text decoder 202 exist in the set of training attribute values 138 to decide whether one or more of the item attributes 150 are a zero-shot case (i.e., an attribute not previously observed) or not a zero shot case (i.e., an attribute that is similar to or the same as a previously observed attribute). To determine whether the item attributes 150 are or are not a zero-shot case, the fusor 304 compares a cosine similarity between an output from the image caption model 208 (e.g., the image caption 148 to be used as the text based correction 314) and represented by the symbol A_{P}, and the outputs A_{D} from the text decoder 202. In response to determining that the image caption model 208 output A_{P} has a cosine similarity to the text decoder 202 output A_{D} that is close to one, then the fusor 304 uses the image caption 148 output A_{P} from the image caption model 208 to correct the output from the text decoder 202 A_{D}. If the two outputs are quite different, the fusor 304 treats the analysis of the item attributes 150 as including at least one attribute that represents a zero-shot case.

In some cases, one or more prompts 312 are input to the image caption model 208, which uses machine learning to generate the image caption 148 based on the digital image 114 and based further on the prompts 312 (e.g., including text or other modes of question inputs requesting a specific attribute to be mentioned in the image caption 148). For example, the prompts 312 include questions posed to the image caption model 208, such as “What is the attribute of the item?” and the image caption 148 includes an answer, such as conveying a type attribute, a brand attribute, a color attribute, and so forth, from the attribute training values 138. As another example, the prompts 312 include statements such as “this image depicts a high heel leather boot” and the image caption 148 includes “leather” and “high heel” as specific attributes of the depicted “boot.” The image caption 148, based on the prompts 312, or based on the digital image 114 alone, produces the text based correction 314, which when combined with the text decoder 202 outputs, conveys accurate and meaningful item information output as the item attributes 150.

In at least one example, the system 300 includes an optical character recognition model 306 configured to extract visual text 308 from the digital image 114 to be used as the image based correction 310, for example, when the output from the text decoder 202 appears as a zero-shot case. The OCR model 306 detects the visual text 308 based on the following:

$$T = OCR ( I ) = \{ t \vert {c}_{t} > {τ}_{c} \qquad Equation ( 3 )$$

In the Equation (3), cₜ is a token confidence value and τ_{c} is a confidence threshold. In some cases, the item attributes 150 are predetermined based on an existing set of attribute values that indicate type, color, brand, capacity, etc. The predetermined attributes are directly inferable by the text decoder 202. However, new, or unknown values not among the predetermined attributes (e.g., a long wallet, a red color, a brand, a twelve ounce size, a one point weight, etc.) vary for different products and represent zero-shot cases, such as when an item has new attributes not previously observed by the system 300. OCR tokens T output from the OCR model 306 are usable to further correct the image caption 148 output A_{P}. In response to determining that the tokens T output from the OCR model 306 have a cosine similarity to the text decoder 202 output A_{D} that is close to one, then the fusor 304 uses the tokens T to correct the output from the text decoder 202 A_{D}. If the two outputs are quite different, the fusor 304 treats the analysis of the item attributes 150 as including at least one attribute that represents a zero-shot case. For attribute value zero-shot cases, the OCR tokens T are used alone by the fusor 304 to correct the image caption 148 output A_{P} generated based on the prompts 312.

The fusor 304 receives the outputs from the text decoder 202 and one or more of the image based correction 310 and the text based correction 314 to improve the text decoder 202 outputs A_{P}. As one example, the fusor 304 replaces at least one item attribute from the item attributes 150 obtained from the text decoder with a corresponding attribute training value from the attribute training values 138 when that attribute does not appear in the attribute training values 138. A comparison (e.g., a cosine similarity, or other similarity analysis) is performed by the fusor 304 to select the corresponding attribute training value to replace the at least one attribute based on the comparison, e.g., an amount of similarity between the at least one item attribute and the corresponding attribute training value. For example, if the cosine similarity between the two values is close to one, then there is no replacement. If the cosine similarity is less than one, then the original attribute output from the text decoder 202 is modified, adjusted, or outright replaced by the similar attribute from the attribute training values.

Additional details of the correction process are shown the following table, which addresses hallucination problems and improves the zero-shot performance on out-of-domain attribute value:

TABLE 1
Algorithm 1: Zero-shot Inference Correction

Input :Aspects A_{D}, A_{P}, OCR tokens T and distance threshold τ_{d}
Output:Final Aspects A
for a_{D} in A_{D} do

| \| | if get_attribute(a_{D}) ∈ get_attribute(A_{P}) then | | |
|---|---|---|---|
| \| | \| | if cosine_similarity(get_value(a_{D}), get_value(a_{P})) > τ_{d} | |
| \| | \| | then | |
| \| | \| | \| | A.update(a_{P}) |
| \| | \| | else | |
| \| | \| | \|_{—} | A.update(aᵢ\|max(cosine_similarity(a_{D}, a_{P}\|\|T))) |

| \| | else | |
|---|---|---|
| \|_{—} | \|_{—} | A.update(aᵢ\|max(cosine_similarity(a_{D}, T))) |

return A

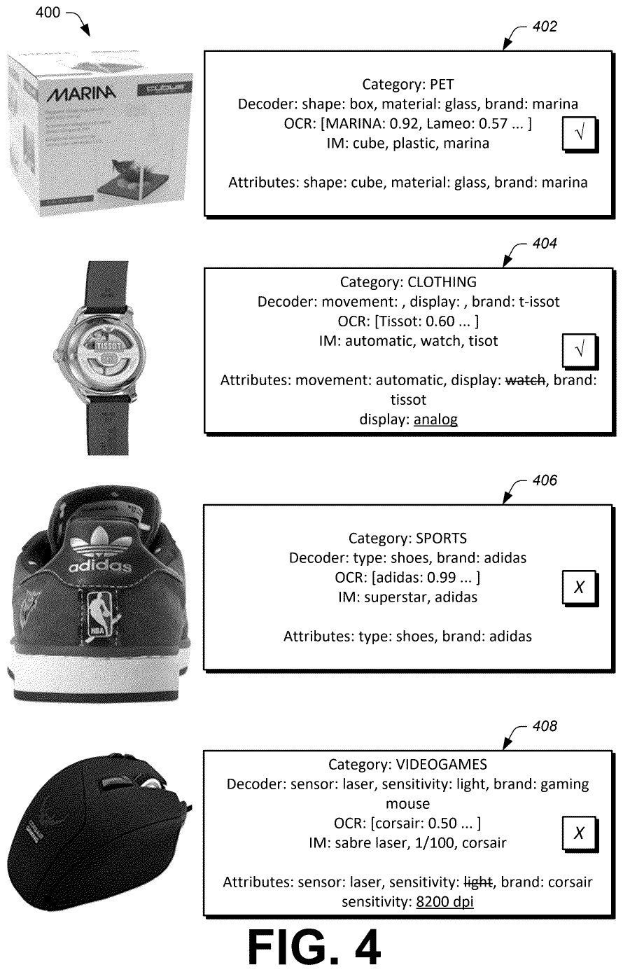

FIG. 4 depicts an example of a user interface 400 for listing items using aspects of image based attribute generation for item descriptions. The user interface 400 is an example feature of the user interface 110 presented by the computing device 102. For example, the application 108 receives the output data 124 from the item description system 104 and uses the output data 124 to construct the user interface 400 to update the user interface 110.

There are four item listings shown in FIG. 4, including listing 402, listing 404, listing 406, and listing 408. Each listing in the user interface 400 represents the item description 152, including the item attributes 150, derived for an item depicted in different examples of the digital image 114. The item description 152 in each listing in the user interface 400 includes an image caption (e.g., based on the image caption 148) presented in the user interface 400 near a corresponding digital image of that item. In addition, the example of FIG. 4 depicts descriptive content for the item that is the subject of each item listing presented in the user interface 400.

In some cases, the computing device 102 (e.g., the application 108) manages the user interface 110 and the user interface 400 to cause the computing device 102 to initiate various tasks. For example, the computing device 102 sends the input data 112 including a request that the description system interface 120 automatically output the item listings 402, 404, 406, and 408 for publishing through an item listing service (e.g., over the networks 106, on the internet). As noted by the strikethrough text embedded in the listing 404 and the listing 408, corrections have been applied by the fusor 304 to change “display: watch” to “display: analog”, and to change “sensitivity: light” to “sensitivity: 8200 dpi”, respectively.

FIG. 5 is a block diagram depicting an example system 500 that is operable to perform aspects of image based attribute generation for item descriptions. The system 500 is an example of the image caption model 208.

In some examples, the image caption model 208 is based on a multimodal large language model (MLLM) framework that receives the digital image 114 as input, and generates the image caption 148, and optionally the item attributes 150 and the item description 152, based on the digital image 114. The MLLM framework enables the image caption model 208 to generate a caption pool 502 of one or more caption candidates 504. Each of the caption candidates 504 describes attributes of an item depicted by the digital image 114, which are converted from embeddings extracted by a different multimodal large language model. The caption pool 502 includes a collection of different caption candidates 504 of the digital image 114, which improves robustness of the output from the image caption model 208. As one example, a first caption candidate includes a ten word description of the digital image 114, and a second caption candidate includes more or fewer words in a description of the digital image 114. In variations, two or more different caption candidates 504 include overlapping (e.g., similar) portions of text describing the digital image 114 in combination with dissimilar portions of text describing different aspects of the digital image 114. Each of the different caption candidates 504 included in the caption pool 502 is generated using a different multimodal large language model from a subset of multimodal large language models 506. The subset of multimodal large language models 506, for instance, is selected from a plurality of multimodal large language models 508 using a model selector 510.

The model selector 510 is configurable to select the subset of multimodal large language models 506 used to generate the one or more caption candidates 504 based on previous performance of each of the machine learning models when used to generate a previous caption candidate from a previous digital image depicting another item that is of the item type. Likewise, performance of the plurality of multimodal large language models 508 is improved by retraining each of the multimodal large language models 508 to generate image captions based on one or more previously generated item descriptions, previously generated caption candidates, or previously generated attributes produced by that model or another model.

To improve consistency of the caption candidates 504, the caption candidates 504 generated from the subset of the multimodal large language models 506 are selected by the model selector 510 by using a matcher 512 to match portions of the caption candidates 504 with a label sets pool (e.g., the attribute training values 138 used for training the text decoder 202) and identify the caption candidates 504 that are useful for generating the image caption 148 that describes the item attributes 150. The matcher 512 outputs attribute matches 514 with the caption candidates 504. A summarizer 516 (e.g., a large language model) of the image caption model 208 is configurable to combine the caption candidates 504 that match the attribute training values 138 to produce the output data 124 from the image caption model 208, such as the image captions 148 used for training the text decoder 202, the image caption 148 used for correcting the item attributes 150, and so forth, to cause the output from the image caption model 208 and the item description system 104 to be concise and accurate.

### Example Procedures of Image Based Attribute Generation

This section describes examples of procedures, or computer-implemented methods, for dynamic automatic generation of item listings. Aspects of the procedures are implementable in hardware, firmware, or software, or a combination thereof. The procedures are shown as a set of blocks that specify operations performed by one or more devices and are not necessarily limited to the orders shown for performing the operations by the respective blocks.

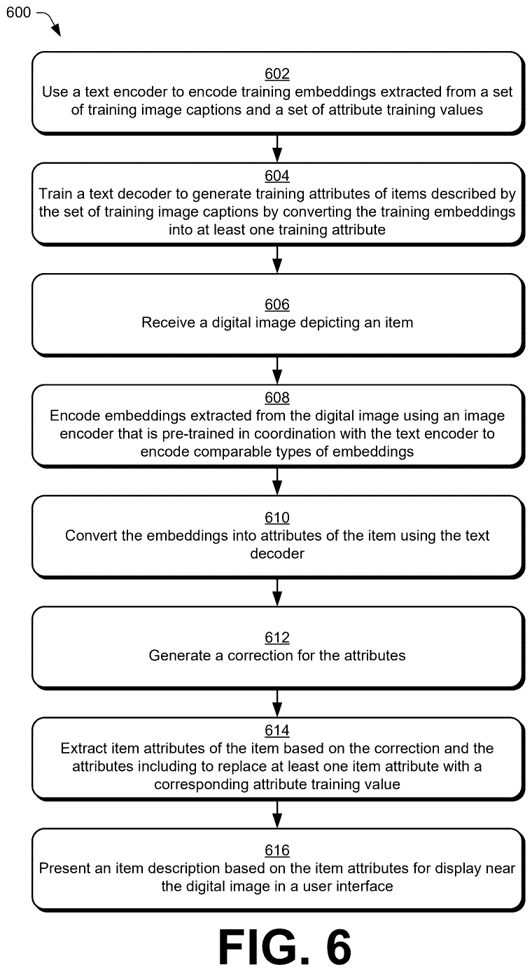

FIG. 6 is a flow diagram that depicts a procedure 600 performed using aspects of image based attribute generation for item descriptions. The procedure 600 starts at step 602, where a text encoder is used to encode training embeddings extracted from a set of training image captions and a set of attribute training values. The text encoder 206, for instance, processes the training image captions 140 and the training attribute values 138 to encode training embeddings based on the text embeddings 212.

At step 604, a text decoder is trained to generate training attributes of items described by the set of training image captions by converting the training embeddings into at least one training attribute. For example, the projector 204 transforms the training embeddings from the text encoder 206 into the attribute embeddings 214 for processing by the text decoder 202. The text decoder 202 outputs the item attributes 150 inferred from the attribute embeddings.

At step 606, a digital image depicting an item is received. The image encoder 302, for instance, receives an input of the digital image 114.

At step 608, embeddings extracted from the digital image are encoded using an image encoder that is pre-trained in coordination with the text encoder to encode comparable types of embeddings. For example, the image encoder 302, which is trained in coordination with the text encoder 206, generates image embeddings 316 extracted from the digital image 114 for output to the projector 204.

At step 610, the embeddings are converted into attributes of the item using the text decoder. For example, the image embeddings 316 generated by the image encoder 302 are received through the projector 204 as the attribute embeddings 214, which are decoded into the item attributes 150.

At step 612, a correction for the attributes is generated. For example, to improve the zero-shot inference capability of the item description system, the visual text 308 and/or the image caption 148 are received by the fusor 304 to apply as corrections to the item attributes 150 output from the text decoder 202.

At step 614, item attributes of the item are extracted based on the correction and the attributes including to replace at least one item attribute with a corresponding attribute training value. For example, the item attributes 150 are updated to improve consistency and relevancy based on the correction derived from the step 612, including to replace at least one of the item attributes 150 with an attribute training value from the training attribute values 138.

At step 616, an item description based on the item attributes is presented for display near the digital image in a user interface. The user interface 110 is updated, for instance, to convey the item description 152 and the item attributes 150, which are in a format for captioning the digital image 114 or generating an item listing for the item depicted by the digital image 114.

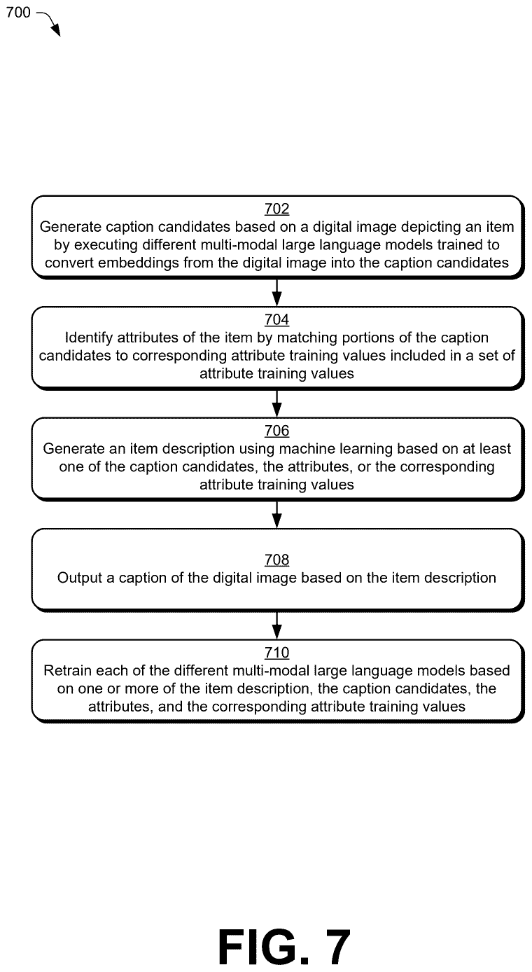

FIG. 7 is a flow diagram that depicts a procedure 700 performed using aspects of image based attribute generation for item descriptions. The procedure 700 is performable by the image caption model 208 to generate the training image captions 140 or to generate the image captions 148, including for applying a correction as described above.

At step 702, caption candidates are generated based on a digital image depicting an item by executing different multimodal large language models trained to convert embeddings extracted from the digital image into the caption candidates. For example, the caption candidates 504 are output from the subset of multimodal large language models 506 chosen by the multimodal large language model selector 510 from among the plurality of multimodal large language models 508.

At step 704, attributes of the item are identified by matching portions of the caption candidates to corresponding attribute training values included in a set of attribute training values. The matcher 512 compares the caption candidates 504 to the training attribute values 138 to identify the attribute matches 514 that correspond to caption candidates 504 that are more likely to have relevant item descriptions than a remainder of the caption candidates 504.

At step 706, an item description is generated using machine learning based on at least one of the caption candidates, the attributes, or the corresponding attribute training values. For example, a subset of the caption candidates 504 and the attribute matches 514 are processed by the summarizer 516 to produce the image caption 148.

At step 708, a caption of the digital image is output based on the item description. For example, the item description output from the summarizer 516 is used as the image caption 148 output from the image caption model 208.

At step 710, each of the different multimodal large language models is retrained based on one or more of the item description, the caption candidates, the attributes, and the corresponding attribute training values. For example, the plurality of multimodal large language models 508 are retrained based on the intermediary results produced throughout the procedure 700 to generate the image caption 148.

Having described examples of procedures in accordance with one or more implementations, consider now an example of a system and device that can be utilized to implement the various techniques described herein.

### Example System and Device for Image Based Attribute Generation

FIG. 8 illustrates an example of a system generally at 800 that includes an example of a computing device 802 that is representative of one or more computing systems and/or devices that are configurable to implement the various techniques described herein. This is illustrated through inclusion of the application 108 and the item description system 104. The computing device 802 is, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interfaces 808 that are communicatively coupled, one to another. Although not shown, the computing device 802 further includes a system bus or other data and command transfer system for communicatively and operatively coupling the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware elements 810 that are configurable as processors, functional blocks, and so forth. An implementation of the hardware elements 810 includes an application specific integrated circuit or other logic device formed using one or more semiconductors. The hardware elements 810 are not limited by the materials from which they are formed, or the processing mechanisms employed therein. For example, processors are comprisable of semiconductor(s) and/or transistors (e.g., electronic integrated circuits (ICs)). In such a context, processor-executable instructions include electronically executable instructions.

The computer-readable media 806 is illustrated as including memory/storage 812. The memory/storage 812 represents memory/storage capacity associated with one or more computer-readable media. The memory/storage 812 is configurable to include volatile media (such as random-access memory (RAM)) and/or nonvolatile media (such as read only memory (ROM), Flash memory, optical disks, magnetic disks, and so forth). The memory/storage 812 is configurable to include fixed media (e.g., RAM, ROM, a fixed hard drive, and so on) as well as removable media (e.g., Flash memory, a removable hard drive, an optical disc, and so forth). The computer-readable media 806 is configurable\in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive, or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

An implementation of the described modules and techniques are stored on or transmitted across some form of computer-readable media. The computer-readable media is configurable to include a variety of media to be accessed by the computing device 802. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which is accessible by a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form to implement at least some aspects of the techniques described herein, such as to perform one or more instructions. Hardware examples include components of an integrated circuit or on-chip system, an application-specific integrated circuit (ASIC), a field-programmable gate array (FPGA), a complex programmable logic device (CPLD), and other implementations in silicon or other hardware. In this context, hardware is operable as a processing device that performs program tasks defined by instructions and/or logic embodied by the hardware as well as a hardware utilized to store instructions for execution, e.g., the computer-readable storage media described previously.

Combinations of the foregoing are configurable to implement various techniques described herein. Accordingly, software, hardware, or executable modules are implemented as one or more instructions and/or logic embodied on some form of computer-readable storage media and/or by one or more hardware elements 810. The computing device 802 is configurable to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing system 804. The instructions and/or functions are executable/operable by one or more articles of manufacture (for example, one or more computing devices 802 and/or processing systems 804) to implement techniques, modules, and examples described herein.

The techniques described herein are supported by various configurations of the computing device 802 and are not limited to the specific examples of the techniques described herein. This functionality is implementable at least in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. Examples of the resources 818 include applications and/or data that can be utilized while computer processing is executed on servers that are remote from the computing device 802. Resources 818 can also include services provided over the Internet and/or through a subscriber network, such as a cellular or Wi-Fi network.

The platform 816 is configurable to abstract resources and functions to connect the computing device 802 with other computing devices. The platform 816 is also configurable to serve to abstract scaling of resources to provide a corresponding level of scale to encountered demand for the resources 818 that are implemented via the platform 816. Accordingly, in an interconnected device embodiment, implementation of functionality described herein is distributed throughout the system 800. For example, the functionality is implemented in part on the computing device 802 as well as via the platform 816 that abstracts the functionality of the cloud 814.

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
receiving a digital image depicting an item;
encoding one or more embeddings extracted from the digital image using an image encoder implemented by at least one machine learning model;
converting the one or more embeddings into at least one attribute of the item using a text decoder of the at least one machine learning model that is trained based on a set of attribute training values;
generating a correction for the at least one attribute; and
extracting item attributes of the item based on the correction and the at least one attribute including to replace at least one item attribute with a corresponding attribute training value from the set of attribute training values.

2. The computer-implemented method of claim 1, further comprising:
encoding one or more training embeddings extracted from a set of training image captions and a set of attribute training values using a text encoder implemented by the at least one machine learning model; and
training the text decoder to generate training attributes of items described by the set of training image captions by converting the training embeddings into at least one training attribute to convert the one or more embeddings into the at least one attribute of the item.

3. The computer-implemented method of claim 2, wherein the image encoder and the text encoder each have learning capabilities disabled to maintain consistency between the one or more embeddings and the one or more training embeddings.

4. The computer-implemented method of claim 2, wherein the image encoder and the text encoder are pre-trained in coordination to encode comparable types of embeddings extracted from the digital image and the set of training image captions.

5. The computer-implemented method of claim 1, wherein generating the correction includes generating an image caption by an image caption model based on the digital image, and generating the correction based on the image caption.

6. The computer-implemented method of claim 5, wherein the image caption model uses machine learning to generate the image caption based on the digital image and based further on a prompt requesting a specific attribute.

7. The computer-implemented method of claim 6, wherein encoding the one or more embeddings extracted from the digital image includes encoding the one or more embeddings based further on the prompt requesting the specific attribute.

8. The computer-implemented method of claim 1, wherein the at least one item attribute is replaced with the corresponding attribute training value when the at least one item attribute does not appear in the set of attribute training values.

9. The computer-implemented method of claim 8, wherein the corresponding attribute training value is selected based on a comparison between the at least one item attribute and the corresponding attribute training value.

10. A non-transitory computer readable medium comprising instructions that when executed cause one or more processors to perform operations including:
generating a caption pool of one or more caption candidates obtained from an image caption model based on a digital image depicting an item by executing different multimodal large language models that convert embeddings extracted from the digital image into attributes of the item described by the one or more caption candidates;
identifying at least one attribute of the item by matching at least one caption candidate to a corresponding attribute training value included in a set of attribute training values;
generating an item description using machine learning based on at least one of the one or more caption candidates, the at least one attribute, or the corresponding attribute training value; and
retraining each of the different multimodal large language models based on training data that includes one or more of the item description, the one or more caption candidates, the at least one attribute, and the corresponding attribute training value.

11. A system comprising:
one or more processors; and
a computer-readable storage medium that stores instruction executed by the one or more processors to perform operations including:
receiving a digital image depicting an item;
generating a caption pool of one or more caption candidates based on the digital image;
identifying at least one attribute of the item described by the one or more caption candidates by matching at least one caption candidate to a corresponding attribute training value included in a set of attribute training values;
generating an item description using machine learning based on at least one of the one or more caption candidates, the at least one attribute, or the corresponding attribute training value; and
presenting the item description for display near the digital image in a user interface.

12. The system of claim 11, wherein the one or more caption candidates are obtained from an image caption model that uses at least one machine learning model to generate image captions of digital images.

13. The system of claim 12, wherein the image caption model uses a plurality of machine learning models individually trained to generate the image captions.

14. The system of claim 13, wherein each machine learning model from the plurality of machine learning models is a different multimodal large language model individually trained to generate the image captions.

15. The system of claim 14, wherein each multimodal large language model from the plurality of machine learning models is individually retrained to generate the image captions based on one or more previously generated item descriptions, previously generated caption candidates, and previously generated attributes.

16. The system of claim 13, wherein the at least one attribute describes an item type, and the image caption model selects each machine learning model used to generate the one or more caption candidates based on previous performance of that machine learning model when used to generate a previous caption candidate from a previous digital image depicting another item that is of the item type.

17. The system of claim 11, wherein the item description comprises an image caption presented near the digital image in the user interface.

18. The system of claim 11, wherein the item description comprises descriptive content for an item listing for the item.

19. The system of claim 18, wherein the operations further include automatically outputting the item listing for publishing through an item listing service.

20. The system of claim 11, wherein the item description is generated automatically in response to receiving the digital image, without receiving intermediary user input.
